(19) United States
(12) Patent Application Publication
(10) Pub. No.: US 2009/0148805 A1
(43) Pub. Date: Jun. 11, 2009

(54) PREVISUALIZATION OF DENTAL WORK

(76) Inventor: John C. Kois, Federal Way, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/330,337

(22) Filed: Dec. 8, 2008

Related U.S. Application Data
(60) Provisional application No. 60/992,945, filed on Dec. 6, 2007.

(51) Int. Cl. A61C 7/08; A61C 7/00

(52) U.S. Cl. 433/24; 433/6

(57) ABSTRACT

The invention relates to a dental arch overlay for previsualizing the results of a proposed course of dental treatment in a patient. The dental arch overlay includes a graphic layer with a color image of teeth that graphically simulates the results of a proposed course of dental treatment, an adhesive layer, and a backing layer. The invention also relates to a method of previsualizing the results of a proposed course of dental treatment in a patient.

### CROSS-REFERENCE TO RELATED APPLICATION

This application claims the benefit of U.S. Provisional Patent Application No. 60/992,945, filed Dec. 6, 2007, the entire disclosure of which is incorporated herein by reference.

### BACKGROUND

The World Health Organization defines dentistry as the science and art of preventing, diagnosing and treating diseases, injuries and malformations of the teeth, jaws, and mouth. As materials, methods, and equipment advance, the capabilities of modern dentistry to repair and correct problems relating to a patient's dental health and appearance have made tremendous strides in recent years.

However, as the capabilities and quality of dentistry technology have advanced, the costs associated with treatment remain relatively high. The increasing corrective capabilities of modern dentistry presents the patient with choices and options that were not previously available. Oftentimes the available procedures may be desirable and/or cosmetic, but not medically necessary, or different options may be available that produce functionally similar results. This leaves the caregiver and the patient with the difficult task of attempting to evaluate the final appearance of the proposed procedure(s), and the decision of whether proceeding with a particular scope of treatment will produce a result that is worth the costs to the patient.

Even for a dental professional, previsualizing the final outcome of a procedure or course of treatment can be challenging. It would be helpful to be able to previsualize the outcome of a procedure in such a way as to display potential results to the patient, as well as to enable the healthcare provider to evaluate various options and to recommend particular courses of treatment.

There is a need for a relatively inexpensive, easily applied means to assist the patient and care provider to previsualize the anticipated outcome of dental and/or orthodontic procedures.

### SUMMARY

The summary is provided to introduce a selection of concepts in a simplified form that are further described below in the detailed description. The summary is not intended to identify key features of the claimed invention, nor is it intended to be used as an aid in determining the scope of the claimed subject matter.

In one aspect, the invention relates to a dental arch overlay for previsualizing the results of a proposed course of dental treatment. The overlay includes:

(a) a graphic layer having a color image of teeth, wherein the color image graphically simulates results of a dental course of treatment;

(b) an adhesive layer disposed over the graphic layer; and

(c) a backing layer disposed over the adhesive layer.

In one embodiment, the dental arch overlay is a maxillary arch overlay.

In one embodiment, the graphic layer comprises an edge that is precision cut to a profile shape of the color image of teeth.

In one embodiment, the graphic layer is consistent in size and shape with human teeth and gums.

In one embodiment, the graphic layer is printed on a clear substrate. In one embodiment, the clear substrate is a 0.005 inch thick polycarbonate substrate.

In one embodiment, the adhesive layer comprises a first adhesive layer and a second adhesive layer. In one embodiment, the first adhesive layer comprises a gel-type adhesive. In one embodiment, the second adhesive layer comprises a medical grade adhesive.

In one embodiment, the backing layer is a 0.007 inch thick polyester layer.

In one embodiment, the maxillary arch overlay further comprises a static cling masking layer disposed over the backing layer.

In one embodiment, the peripheral dimension of the graphic layer is greater than the peripheral dimension of the adhesive layer and the backing layer.

In one embodiment, the overlay is suitable for being removably affixed to a patient's dentition.

In one embodiment, there are graduated sizes of the dental arch overlay.

In another aspect, the invention provides a method of previsualizing the results of a proposed course of dental work in a patient. The method includes the steps of:

(a) measuring the width of a central incisor in a patient;

(b) selecting an appropriate dental arch overlay, wherein the dental arch overlay comprises an adhesive-backed, precision cut graphic overlay depicting the intended results of a proposed course of dental work;

(c) trimming the dental arch overlay to a length that is suitable for the patient's dentition;

(d) drying the patient's teeth;

(e) removing a protective covering of an adhesive layer of the dental arch overlay; and

(f) positioning the dental arch overlay over the patient's teeth.

In one embodiment, the dental arch overlay is a maxillary arch overlay.

In one embodiment, the dental arch overlay covers only a portion of the patient's dentition.

In another aspect, the invention provides a method of previsualizing the results of a proposed course of dental work in a patient. The method includes the steps of:

(a) selecting an appropriate dental arch overlay, wherein the dental arch overlay comprises an adhesive-backed, precision cut graphic overlay depicting the intended results of a proposed course of dental work;

(b) trimming the dental arch overlay to a length that is suitable for a model of a patient's dentition;

(c) removing a protective covering of an adhesive layer of the dental arch overlay; and

(d) applying the dental arch overlay to the model of the patient's dentition.

In one embodiment, the dental arch overlay is a maxillary arch overlay.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an environmental view, showing the maxillary arch overlay according to the present invention applied to a patient for previsualizing a proposed procedure, and FIG. 1A shows a close-up of the patient and the maxillary arch overlay;

FIG. 2 is a plan view of the exemplary maxillary arch overlay shown in FIG. 1;

FIG. 3 is an exploded schematic view showing the various layers in the exemplary maxillary arch overlay shown in FIG. 1; and

FIG. 4 is a graphic view showing an exemplary image of the maxillary arch overlay shown in FIG. 1.

### DETAILED DESCRIPTION

An apparatus, and method of using the apparatus, for previsualizing the final result from a proposed course of dental treatment is described herein, with reference to the figures. The present invention provides many advantages and new functionality. For example, the disclosed apparatus and method may be used to: (1) facilitate aesthetic orientation for mounting the maxillary cast on an articulator; (2) allow the patient and the provider to preview or previsualize changes in tooth position relative to the face of the patient; and/or (3) allow the provider to preview with the patient concerns regarding, for example, missing anatomical structure. The disclosed device and method are very simple and inexpensive, and provide rapid patient feedback with more accurate aesthetic analysis of the maxillary arch.

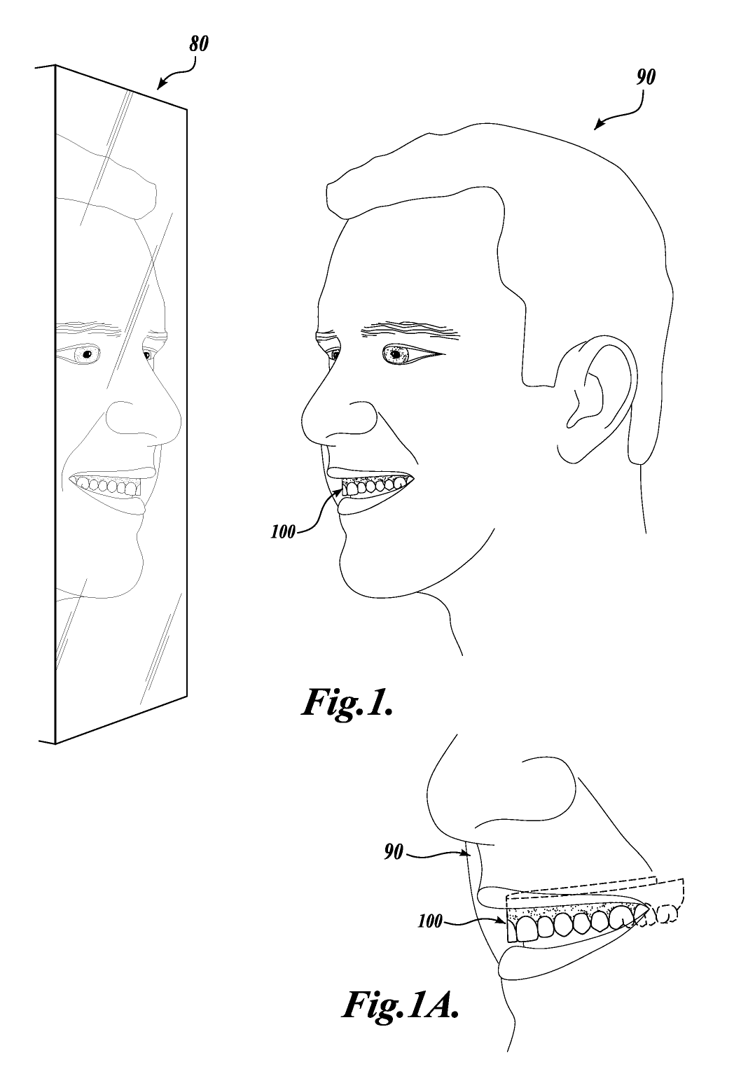

An environmental view of a maxillary arch overlay 100 in accordance with the present invention is illustrated in FIG. 1, which shows a patient 90 having a maxillary arch overlay 100 made in accordance with the present invention, and applied generally to the patient's teeth (not visible), such that the patient 90 can previsualize, for example by looking in a mirror 80, the expected appearance of a prescribed procedure or course of treatment. A close-up view of the maxillary arch overlay 100 installed on the patient 90 is shown in FIG. 1A.

The maxillary arch overlay 100 is a thin and flexible graphic that is temporarily affixed directly onto the patient's upper teeth and generally overlies the maxillary arch and the associated teeth. The overlay 100 comprises a proportionate and realistic-color panel that is sized and shaped to correspond to the teeth and upper gums of the patient.

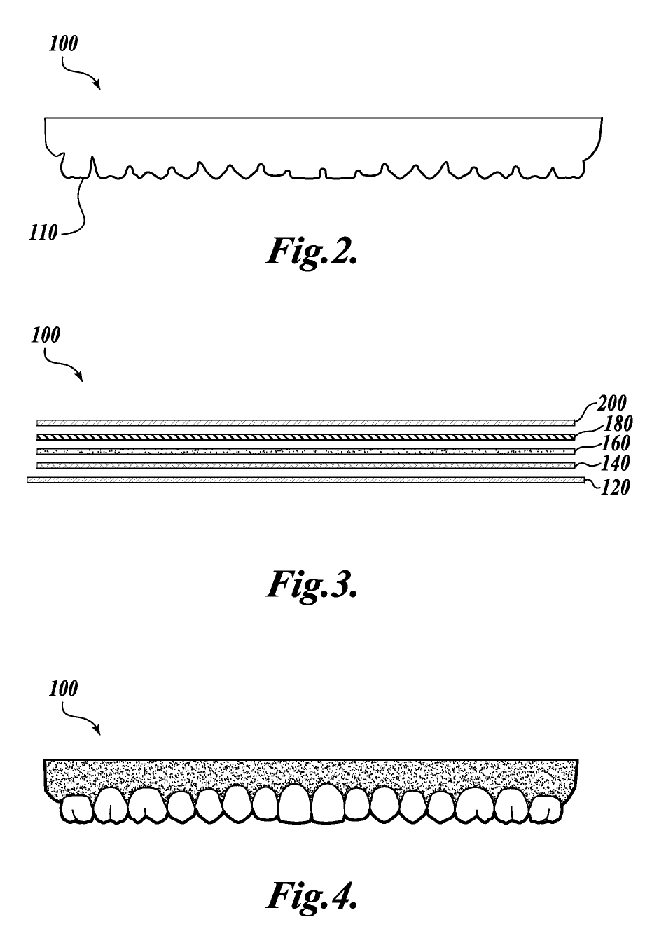

FIG. 2 shows a plan view of the maxillary arch overlay 100, wherein a lower edge 110 of the overlay is precision cut to the profile shape of desired or exemplary incisors, canines and molars. In one embodiment, the maxillary arch overlay 100 measures 5.234 inches wide by 0.578 inches high. However, it is contemplated that the maxillary arch overlay 100 may be produced in a variety of sizes that are intended to be life-size images of exemplary gums and teeth, such that a dentist, orthodontist, dental assistant or other healthcare provider can select an overlay 100 from a calibrated set of overlays to provide a “best fit” for a particular patient.

In one embodiment, a set of graduated-size overlays 100 are produced, all having a specified ratio of tooth widths. To select an appropriate overlay 100, therefore, the healthcare provider can simply measure the width of a particular patient's incisor and select the overlay 100 having the same width. Other sizing and selection methods are also contemplated. For example, different series of overlays may be produced to account for known variations in tooth and maxillary arch geometry, for example to accommodate gender, race and/or age differences.

As shown in the exploded layer detail schematic of FIG. 3, the maxillary arch overlay 100 has a graphic layer 120. An inner or first adhesive layer 140 is disposed over the graphic layer 120. In one embodiment, the first adhesive layer 140 comprises a gel-type adhesive. A suitable exemplary gel-type adhesive for use in overlay 100 is designated AmGel AG602 adhesive, and is marketed by AmGel® Technologies, a division of Axelgaard Manufacturing Co., Ltd., with headquarters in Fallbrook, Calif. It will be appreciated that the gel-type adhesive provides a soft, flexible and cushioning substrate, protecting the patient's gums and other oral soft tissue, without adding unnecessary thickness to the overlay 100. A second adhesive layer 160 is disposed over the first adhesive layer 140. The second adhesive layer 160 comprises a medical grade adhesive that is adapted to adhere to a patient's teeth. A suitable exemplary medical grade adhesive is medical grade 1517 adhesive produced by the 3M Company, with headquarters in St. Paul, Minn.

As indicated in FIG. 2, in the exemplary overlay 100, the first adhesive layer 140 and the second adhesive layer 160 are precision precut to generally match the peripheral dimension of the overlay 100, for example, as shown in FIG. 1. However, the adhesive layers 140, 160 are cut to a slightly smaller dimension, such that the adhesive layers 140, 160 are generally not visible when the overlay is in use by a patient, even if there is slight displacement or spread of the adhesive layers during application.

Referring to FIG. 3, a peel-away or backing layer 180, for example a 0.007 inch thick polyester layer, is provided to protect the second adhesive layer 160 prior to use. An optional static cling masking layer 200 is also provided on the backing layer 180 to separate the maxillary arch overlays prior to use.

FIG. 4 provides a graphic image of the desired teeth and gums for the overlay 100. A color version of the graphic image shown in FIG. 4 is preferably back printed on the graphic layer 120. In one embodiment, the graphic layer 120 may comprise a clear substrate, such as a 0.005 inch clear polycarbonate substrate, that is precision cut to the desired dimensions.

To produce the maxillary arch overlay 100, polycarbonate graphic layers 120 are printed with the desired graphic onto sheets, preferably using water-based inks, and cut to a specified part shape and size. Separately, the adhesive layers 140, 160, as well as the backing layers 180, are combined in sheets, and laser cut to the desired size and shape, slightly smaller than the size of the graphic layer 120, as discussed above. The adhesive layers 140, 160 and the graphic layer 120 are applied to each other with the gel-type first adhesive layer 140 receiving the graphic layer 120. The assembled overlays 100 are then interleaved, inspected and packaged.

In a preferred embodiment, the teeth sizing is selected in accordance with the Golden Proportion to simulate tooth sized and gingival contour. This proportional relationship of the soft tissue component along with the hard tissue component provides aesthetic benefits for previsualization.

In an exemplary application of the maxillary arch overlay 100, a healthcare provider: (i) measures the width of the central incisor; (ii) selects the corresponding maxillary arch overlay; (iii) trims the overlay to length to fit the patient's dentition; (iv) dries the existing maxillary teeth; (v) removes the protective covering of the adhesive layer; (vi) positions the maxillary arch overlay over the patient's teeth; (vii) vertically adjusts the maxillary arch overlay to create the correct display with lips in repose and full smile; (viii) levels the maxillary arch overlay in the face based on the natural head posture; and (ix) allows the patient to preview.

The maxillary arch overlay 100 allows the patient to previsualize the effect that proposed procedures will actually have on the patient's appearance, and thereby aid the patient in deciding on an appropriate course of treatment. In addition, the overlay assists the healthcare provider in selecting and advising the patient regarding proposed courses of treatment.

In particular, it will be appreciated by persons of skill in the art that the maxillary arch overlay 100 will help the healthcare professional to determine parameters such as teeth placement and the like to improve the overall outcome for the patient.

In another mode of use, the maxillary arch overlay 100 may be used by the healthcare professional on models of teeth to help determine teeth placement and the like.

Although the exemplary embodiment shown in FIGS. 1 through 4 is a maxillary arch overlay, it will be readily apparent to persons of skill in the art that a similar dental overlay may be provided for the mandibular arch without departing from the present invention.

In another mode of usage, it is contemplated that portions of the maxillary arch and teeth, less than the entire arch, may be produced and used for previsualization and the like, as discussed above, or the maxillary arch overlay 100 described above may be trimmed to only cover a portion of the maxillary arch for particular applications.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A dental arch overlay for previsualizing the results of a proposed course of dental treatment, the overlay comprising:
(a) a graphic layer having a color image of teeth, wherein the color image graphically simulates results of a dental course of treatment;
(b) an adhesive layer disposed over the graphic layer; and
(c) a backing layer disposed over the adhesive layer.

2. The dental arch overlay of claim 1, wherein the overlay is a maxillary arch overlay.

3. The dental arch overlay of claim 1, wherein the graphic layer comprises an edge that is precision cut to a profile shape of the color image of teeth.

4. The dental arch overlay of claim 1, wherein the graphic layer is consistent in size and shape with human teeth and gums.

5. The dental arch overlay of claim 1, wherein the graphic layer is printed on a clear substrate.

6. The dental arch overlay of claim 5, wherein the clear substrate is a 0.005 inch thick polycarbonate substrate.

7. The dental arch overlay of claim 1, wherein the adhesive layer comprises a first adhesive layer and a second adhesive layer.

8. The dental arch overlay of claim 7, wherein the first adhesive layer comprises a gel-type adhesive.

9. The dental arch overlay of claim 7, wherein the second adhesive layer comprises a medical grade adhesive.

10. The dental arch overlay of claim 1, wherein the backing layer is a 0.007 inch thick polyester layer.

11. The dental arch overlay of claim 1, wherein the overlay further comprises a static cling masking layer disposed over the backing layer.

12. The dental arch overlay of claim 1, wherein the peripheral dimension of the graphic layer is greater than the peripheral dimension of the adhesive layer and the backing layer.

13. The dental arch overlay of claim 1, wherein the overlay is suitable for being removably affixed to a patient's dentition.

14. The dental arch overlay of claim 1, further comprising graduated sizes of the dental arch overlay.

15. A method of previsualizing the results of a proposed course of dental work in a patient, the method comprising the steps of:
(a) measuring the width of a central incisor in a patient;
(b) selecting an appropriate dental arch overlay, wherein the dental arch overlay comprises an adhesive-backed, precision cut graphic overlay depicting the intended results of a proposed course of dental work;
(c) trimming the dental arch overlay to a length that is suitable for the patient's dentition;
(d) drying the patient's teeth;
(e) removing a protective covering of an adhesive layer of the dental arch overlay; and
(f) positioning the dental arch overlay over the patient's teeth.

16. The method of claim 15, wherein the dental arch overlay is a maxillary arch overlay.

17. The method of claim 15, wherein the dental arch overlay covers only a portion of a patient's dentition.

18. A method of previsualizing the results of a proposed course of dental work in a patient, the method comprising the steps of:
(a) selecting an appropriate dental arch overlay, wherein the dental arch overlay comprises an adhesive-backed, precision cut graphic overlay depicting the intended results of a proposed course of dental work;
(b) trimming the dental arch overlay to a length that is suitable for a model of a patient's dentition;
(c) removing a protective covering of an adhesive layer of the dental arch overlay; and
(d) applying the dental arch overlay to the model of the patient's dentition.

19. The method of claim 18, wherein the dental arch overlay is a maxillary arch overlay.
